(19) United States
(12) Patent Application Publication
(10) Pub. No.: US 2009/0180069 A1
(43) Pub. Date: Jul. 16, 2009

(54) LIQUID CRYSTAL DEVICE AND ELECTRONIC APPARATUS

(75) Inventor: Joji Nishimura, Matsumoto-shi (JP)

Correspondence Address: OLIFF & BERRIDGE, PLC, P.O. BOX 320850, ALEXANDRIA, VA, 22320-4850, US

(73) Assignee: Epson Imaging Devices Corporation, Azumino-shi (JP)

(21) Appl. No.: 12/349,250

(22) Filed: Jan. 6, 2009

(30) Foreign Application Priority Data
Jan. 11, 2008 (JP) 2008-004015

(51) Int. Cl. G02F 1/1343

(52) U.S. Cl. 349/139

(57) ABSTRACT

A liquid crystal device includes: lower electrodes which are formed in an element substrate; an insulating film which is stacked on the lower electrodes; upper electrodes which are stacked on the insulating film and each provided with a slit for generating a fringe electric field; a counter substrate which is formed opposite the element substrate; liquid crystal which is interposed between the counter substrate and the element substrate; a shield electrode which is formed in a potentially floating state on an inner surface of the counter substrate opposed to the element substrate; and a resin layer which is formed on the inner surface of the counter substrate.

### BACKGROUND

1. Technical Field

The present invention relates to a so-called fringe field switching (hereinafter, referred to as FFS) mode liquid crystal device and an electronic apparatus equipped with the liquid crystal device.

2. Related Art

As a liquid crystal device used for a cellular phone or a portable computer, a liquid crystal device such as a FFS mode liquid crystal device or an in-plane switching (hereinafter, referred to as IPS) mode liquid crystal device, which drives liquid crystal by use of a transverse electric field, was put to practical use in order to realize a wide viewing angle. As shown in FIG. 15A, in the IPS mode liquid crystal device, the edge of a pixel electrode 507 and the edge of a common electrode 509 are spaced from each other in a transverse direction on an element substrate 510. However, in the FFS mode liquid crystal device, the edge of one of a pixel electrode and a common electrode formed in an upper layer overlaps with the other thereof formed in a lower layer in plan view with an insulating film interposed therebetween.

In the IPS mode liquid crystal device, an electrode which drives liquid crystal is not formed in a counter substrate 520. Therefore, it is easy for the counter substrate 520 to be subjected to electrification due to static electricity. Since alignment of liquid crystal 550 is disturbed due to the electrification, high quality display cannot be realized. Moreover, once the electrification occurs due to the static electricity, it is not easy to remove the static electricity.

In order to solve this problem, as shown in FIG. 15A, there was suggested an IPS mode liquid crystal device in which a shield electrode 529 is formed in an opposite surface (outer surface) of a surface of the counter substrate 520 facing the element substrate 510 and a predetermined potential is applied to the shield electrode 529. Moreover, as shown in FIG. 15B, there was suggested a liquid crystal device in which in a counter substrate 520, a shield electrode 529 is provided on a color filter 524 so as to be formed on a surface (inner surface) facing an element substrate 510 and a predetermined potential is applied to the shield electrode 529 (see FIGS. 2A and 2B in JP-A-2001-25263).

However, when the shield electrode 529 is provided on the outer surface of the counter substrate 520, as shown in FIG. 15A, a film forming process of forming the shield electrode 529 or a conducting process of electrically connecting the shield electrode 529 to a wire of the element substrate 510 have to be performed after assembly of a liquid crystal panel. Therefore, productivity is low and a great loss occurs when a defective device is made after the assembly of the liquid crystal panel. In order to solve this problem, as shown in FIG. 15B, the shield electrode 529 may be provided on the inner surface of the counter substrate 520.

However, the IPS mode liquid crystal device has a problem that contrast deteriorates or the like when the shield electrode 529 is provided on the inner surface of the counter electrode 520, as illustrated with reference to FIG. 15C. For example, when the shield electrode 529 is provided on the inner surface of the counter substrate 520 and the shield electrode 529 is fixed to a ground potential, transmissivity is considerably decreased in comparison to a case (characteristic shown by a line L50/Ref) where the shield electrode 529 is not formed, as indicated by a line L51 (CF UPPER GND) of FIG. 15c. Here, FIG. 15C is a graph illustrating a relation between a driving voltage for liquid crystal and transmissivity in a normally black mode liquid crystal device. In addition, when the shield electrode 529 is provided on the inner surface of the counter substrate 520 and the shield electrode 529 is in a potentially floating state, transmissivity is improved in comparison to the case where the shield electrode 529 is fixed to the ground potential, as indicated by a line L52 (CF UPPER Flo) in FIG. 15C. However, the transmissivity is very low in comparison to the case where the shield electrode 529 is not formed.

Here, the inventors consider that it is difficult for the FFS mode liquid crystal device to be affected by a potential of the counter substrate even when the same transverse electric field is used, and thus suggest that a shield electrode 29 is provided on an inner surface 20a of a counter substrate 20 in the FFS mode liquid crystal device, as shown in FIGS. 16A and 16B.

However, as shown in FIG. 16A, a pixel electrode 7a, an insulating film 8, and a common electrode 9a are provided on an element substrate 10, a color filter 24 and the shield electrode 29 are stacked in order on the inner surface 20a of the counter substrate 20, and the same potential (common potential VCom) as that of the common electrode 9a is applied to the shield electrode 29. In this case, as indicated by a line L3 (Com UPPER CF UPPER VCom) in FIG. 1, a problem occurs in that the transmissivity is low and contrast is decreased in comparison to the case (data expressed by a line L0 in FIG. 1 (No ITO)) where the shield electrode 29 is not formed. Moreover, as shown in FIG. 16B, the pixel electrode 7a and the common electrode 9a are formed in an upper layer and a lower layer in the element substrate 10, respectively, the color filter 24 and the shield electrode 29 are stacked in order on the inner surface of the counter substrate 20, and the same potential (common potential VCom) as that of the common electrode 9a is applied to the shield electrode 29. In this case, as indicated by a line L7 (Com LOWER CF UPPER VCom) in FIG. 1, the problem also occurs in that the transmissivity is low and contrast is decreased in comparison to the case (data expressed by a line L0 in FIG. 1) where the shield electrode 29 is not formed.

### SUMMARY

An advantage of some aspects of the invention is that it provides a liquid crystal device capable of displaying a high quality image even when a shield electrode shielding static electricity is formed on an inner surface opposed to an element substrate in a counter substrate, and an electronic apparatus equipped with the liquid crystal device.

According to an aspect of the invention, there is provided a liquid crystal device including: lower electrodes which are formed in an element substrate; an insulating film which is stacked on the lower electrodes; upper electrodes which are stacked on the insulating film and each provided with a slit for generating a fringe electric field; a counter substrate which is formed opposite the element substrate; liquid crystal which is interposed between the counter substrate and the element substrate; a shield electrode which is formed in a potentially floating state on an inner surface of the counter substrate opposed to the element substrate; and a resin layer which is formed on the inner surface of the counter substrate.

In the liquid crystal device according to the aspect of the invention, an electrode which drives the liquid crystal is not formed in the counter substrate, but the shield electrode is formed. Therefore, it is difficult for electrification caused due to static electricity to occur in the counter substrate. Even though the electrification caused due to static electricity occurs, alignment of the liquid crystal is not disturbed. Moreover, since the shield electrode is formed on the inner surface of the counter substrate, the shield electrode can be formed in a substrate state before assembly of a liquid crystal panel. Moreover, on the inner surface of the counter substrate opposed to the element substrate, the shield electrode is provided below the resin layer, and the shield electrode is in a potentially floating state. With such a configuration, even when the shield electrode is provided on the inner surface of the counter substrate opposed to the element substrate, the alignment of the liquid crystal is not disturbed by the shield electrode Accordingly, it is possible to display a high quality image such as a high contrast image.

According to another aspect of the invention, there is provided a liquid crystal device including: lower electrodes which are formed in an element substrate; an insulating film which is stacked on the lower electrodes; upper electrodes which are stacked on the insulating film and each provided with a slit for generating a fringe electric field; a counter substrate which is formed opposite the element substrate; liquid crystal which is interposed between the counter substrate and the element substrate; a shield electrode which is formed on an inner surface of the counter substrate opposed to the element substrate; and a resin layer which is stacked next to the shield electrode from the counter substrate. A pixel electrode is formed of one of the lower electrode and the upper electrode and a common electrode is formed of the other thereof. In addition, the shield electrode is opposed to the common electrode, and a potential having the same polarity as that of the common potential applied to the common electrode and having an absolute value higher than that of the common voltage is applied to the shield electrode.

In the liquid crystal device according to this aspect of the invention, an electrode which drives the liquid crystal is not formed in the counter substrate, but the shield electrode is formed. Therefore, it is difficult for electrification caused due to static electricity to occur in the counter substrate. Even though the electrification caused due to static electricity occurs, the alignment of the liquid crystal is not disturbed. Moreover, since the shield electrode is formed on the inner surface of the counter substrate, the shield electrode can be formed in a substrate state before the assembly of a liquid crystal panel. Moreover, on the inner surface of the counter substrate opposed to the element substrate, the shield electrode is provided below the resin layer, and a predetermined potential is applied to the shield electrode. With such a configuration, even when the shield electrode is provided on the inner surface of the counter substrate opposed to the element substrate, the alignment of the liquid crystal is not disturbed by the shield electrode. Accordingly, it is possible to display a high quality image such as a high contrast image.

In the liquid crystal device according to this aspect of the invention, the shield electrode may be electrically connected to a wire formed on the element substrate through an electric conductive member interposed between the element substrate and the counter substrate. With such a configuration, it is possible to easily apply a potential to the shield electrode.

The liquid crystal device according to this aspect of the invention may have a configuration in which the same potential as that of the common electrode opposed to the shield electrode is applied.

The liquid crystal device according to this aspect of the invention may have a configuration in which the potential having the same polarity as that of the common potential applied to the common electrode opposed to the shield electrode and having the absolute value higher than that of the common voltage is applied to the shield electrode may be employed.

The liquid crystal device according to this aspect of the invention may have a configuration in which the common electrode and the shield electrode extend in a strip shape along pixels arranged in a horizontal direction or in a vertical direction and are divided in a direction intersecting the extension direction, and different common potentials are applied to adjacent common electrodes.

In the liquid crystal device according to this aspect of the invention, the resin layer may have a thickness of 2 μm or more and permittivity of 6 or less. With such a configuration, it is possible to surely prevent the alignment of the liquid crystal from being disturbed by the shield electrode.

According to still another aspect of the invention, there is provided a liquid crystal device including: an element substrate in which lower electrodes, an insulating film, and upper electrodes having a plurality of slits which generate a fringe electric field are stacked in order; a counter substrate which is disposed opposite the element substrate; and liquid crystal which is interposed between the counter substrate and the element substrate. In the liquid crystal device, each of pixel electrodes is formed of one of the lower electrode and the upper electrode and each of common electrodes is formed of the other thereof. In addition, an electrode which drives the liquid crystal is not provided on the inner surface of the counter substrate opposed to the element substrate, and a resin layer and a shield electrode in a potentially floating state are stacked on the inner surface in order from the counter substrate.

In the liquid crystal device according to this aspect of the invention, an electrode which drives the liquid crystal is not formed in the counter substrate, but the shield electrode is formed. Therefore, it is difficult for electrification caused due to static electricity to occur. Even though the electrification caused due to static electricity occurs, the alignment of the liquid crystal is not disturbed. Moreover, since the shield electrode is formed on the inner surface of the counter substrate, the shield electrode can be formed in a substrate state before the assembly of a liquid crystal panel. Moreover, on the inner surface of the counter substrate opposed to the element substrate, the shield electrode is provided above the resin layer, and the shield electrode is in a potentially floating state. With such a configuration, even when the shield electrode is provided on the inner surface of the counter substrate opposed to the element substrate, the alignment of the liquid crystal is not disturbed by the shield electrode. Accordingly, it is possible to display a high quality image such as a high contrast image.

In the liquid crystal device according to this aspect of the invention, the resin layer may include a color filter layer. With such a configuration, the color filter can be used as the resin layer or a part of the resin layer.

In the liquid crystal device according to this aspect of the invention, the lower electrode may be a pixel electrode and the upper electrode may be a common electrode extending to a plurality of pixels. With such a configuration, it is possible to easily apply a potential corresponding to a potential of the electrode located in an upper layer in the element substrate to the shield electrode. Moreover, it is possible to surely prevent the alignment of the liquid crystal from being disturbed by the shield electrode.

In the liquid crystal device according to the aspect of the invention, the upper electrode may be a pixel electrode and the lower electrode may be a common electrode extending to a plurality of pixels.

According to still another aspect of the invention, there is provided an electronic apparatus such as a cellular phone or a portable computer equipped with the liquid crystal device described above.

### BRIEF DESCRIPTION OF THE DRAWINGS

The invention will be described with reference to the accompanying drawings, wherein like numbers reference like elements,

FIG. 1 is a graph illustrating variation in transmissivity when a driving voltage for liquid crystal varies in a liquid crystal device of each configuration example according to the invention and a comparative example.

FIG. 2A is a plan view illustrating the liquid crystal device to which the invention is applied and constituent elements formed in the liquid crystal device when viewed from a side of a counter substrate, FIG. 2B is a sectional view taken along the line IIB-IIB, FIG. 2C is an expanded sectional view illustrating an electric conductive configuration between the shield electrode of the counter substrate and wires of an element substrate, and FIG. 2D is a plan view illustrating the electric conductive configuration.

FIG. 3 is an equivalent circuit diagram illustrating the electric configuration of an image display area of the element substrate in the liquid crystal device of the invention.

FIGS. 4A and 4B are a sectional view illustrating one pixel in the liquid crystal device and a plan view illustrating pixels adjacent to each other in the element substrate according to a first embodiment of the invention, respectively.

FIGS. 5A and 5B are a sectional view illustrating one pixel in the liquid crystal device and a plan view illustrating pixels adjacent to each other in the element substrate according to a third embodiment of the invention, respectively.

FIGS. 6A and 6B are a sectional view illustrating one pixel in the liquid crystal device and a plan view illustrating pixels adjacent to each other in the element substrate according to a fifth embodiment of the invention, respectively.

FIGS. 7A and 7B are a sectional view illustrating one pixel in the liquid crystal device and a plan view illustrating pixels adjacent to each other in the element substrate according to a sixth embodiment of the invention, respectively.

FIG. 8 is a sectional view illustrating one pixel in a liquid crystal device according to a modified example of the first to fourth embodiments of the invention.

FIGS. 9A and 9B are graphs illustrating relations between a driving voltage and transmissivity for liquid crystal in the liquid crystal device in the first to fourth embodiments of the invention, when the film thickness and the permittivity of a resin layer are varied.

FIGS. 10A, 10B, and 10C are a block diagram when horizontal line inversion is performed in the liquid crystal device according to the second and fourth embodiments of the invention, a plan view illustrating the pixel configuration, and a schematic explanatory diagram illustrating the cross-section of the pixels, respectively.

FIGS. 11A, 11B, and 11C are a block diagram when vertical line inversion is performed in the liquid crystal device according to the second and fourth embodiments of the invention, a plan view illustrating the pixel configuration, and a schematic explanatory diagram illustrating the cross-section of the pixels, respectively.

FIG. 12 is a graph obtained when a voltage applied to the shield electrode is varied in the liquid crystal device according to the second embodiment of the invention.

FIGS. 13A and 13B are a sectional view illustrating one pixel in the liquid crystal device and a plan view illustrating pixels adjacent to each other in the element substrate according to another embodiment of the invention, respectively.

FIGS. 14A, 14B, and 14C are explanatory diagrams illustrating electronic apparatuses equipped with the liquid crystal device according to the invention.

FIGS. 15A, 15B, and 15C are explanatory diagrams illustrating a known liquid crystal device.

FIGS. 16A and 16B are explanatory diagrams illustrating a liquid crystal device according to a comparative example of the invention.

### DESCRIPTION OF EXEMPLARY EMBODIMENTS

Hereinafter, preferred embodiments of the invention will be described. Layers or constituent elements are illustrated in different scales in order to allow the layers and the constituent elements to be more recognizable in the drawings referred in the below description. In addition, an alignment film or the like is not illustrated. In each of thin film transistors used as pixel switching elements of a liquid crystal device, a source and a drain are switched by an application voltage. In the below description, a side connected to a pixel electrode is assumed to be the drain for convenient description. In addition, in the below description, an expression that “an upper electrode and a lower electrode are overlapped with each other” means that “an upper electrode and a lower electrode are overlapped with each other in plan view”.

### Overview

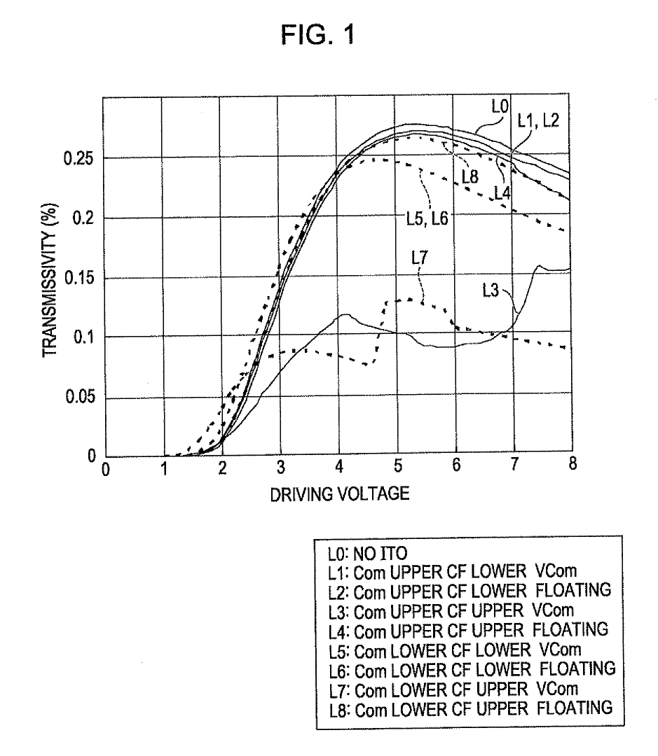

Before each embodiment is described, an overview of the liquid crystal device according to the invention will be described with reference to FIG. 1 and Table 1. FIG. 1 is a graph illustrating variation in transmissivity when a driving voltage for liquid crystal varies in the liquid crystal device according to each configuration example of the invention and a comparative example.

According to the invention, as shown in Table 1, in a normally black mode liquid crystal device using a FFS mode, upper and lower locations of a pixel electrode and a common electrode driving liquid crystal in an element substrate, upper and lower locations of a color filter and a shield electrode in a counter substrate, a potential of the shield electrode (in an application state of a common potential VCom or a potentially floating state (Floating)), and the like are combined to compare each relation between the driving voltage and the transmissivity to a case where the shield electrode is not formed. The results are shown in lines L0 to L8 in FIG. 1. In Table 1, the maximum value of the transmissivity of each liquid crystal device is shown as a ratio (Tmax-to-(Ref) ratio) of the case where the shield electrode is not formed.

TABLE 1

| | CONFIGURATION | LOCATION | POTENTIAL | TMAX | | RELATION | |
|---|---|---|---|---|---|---|---|
| | OF DRIVING | OF SHIELD | OF SHIELD | REF | | WITH THE | CORRESPONDENCE |
| EXAMPLE | ELECTRODE | ELECTRODE | POTENTIAL | RATIO | EVALUATION | INVENTION | OF FIG. 1 |
| CONFIGURATION | COMMON | COLOR | VCOM | 98.0% | ⊚ | FOURTH | L1 |
| EXAMPLE 1 | ELECTRODE | FILTER | | | | EMBODIMENT | |
| | UPPER | LOWER | | | | OF THE | |
| | PIXEL | | | | | INVENTION | |
| CONFIGURATION | ELECTRODE | | Floating | 98.0% | ⊚ | THIRD | L2 |
| EXAMPLE 2 | LOWER | | | | | EMBODIMENT | |
| | | | | | | OF THE | |
| | | | | | | INVENTION | |
| CONFIGURATION | | COLOR | VCOM | 56.2% | X | COMPARATIVE | L3 |
| EXAMPLE 3 | | FILTER | | | | EXAMPLE | |
| CONFIGURATION | | UPPER | Floating | 97.0% | ⊚ | SIXTH | L4 |
| EXAMPLE 4 | | | | | | EMBODIMENT | |
| | | | | | | OF THE | |
| | | | | | | INVENTION | |
| CONFIGURATION | COMMON | COLOR | VCOM | 89.3% | ◯ | SECOND | L5 |
| EXAMPLE 5 | ELECTRODE | FILTER | | | | EMBODIMENT | |
| | LOWER | LOWER | | | | OF THE | |
| | PIXEL | | | | | INVENTION | |
| CONFIGURATION | ELECTRODE | | Floating | 89.3% | ◯ | FIRST | L6 |
| EXAMPLE 6 | UPPER | | | | | EMBODIMENT | |
| | | | | | | OF THE | |
| | | | | | | INVENTION | |
| CONFIGURATION | | COLOR | VCOM | 47.1% | X | COMPARATIVE | L7 |
| EXAMPLE 7 | | FILTER | | | | EXAMPLE | |
| CONFIGURATION | | UPPER | Floating | 96.0% | ⊚ | FIFTH | L8 |
| EXAMPLE 8 | | | | | | EMBODIMENT | |
| | | | | | | OF THE | |
| | | | | | | INVENTION | |

The configuration examples 1 to 8 shown in Table 1 correspond as follows:

Configuration Example 1: Fourth Embodiment of the invention;

Configuration Example 2: Third Embodiment of the invention;

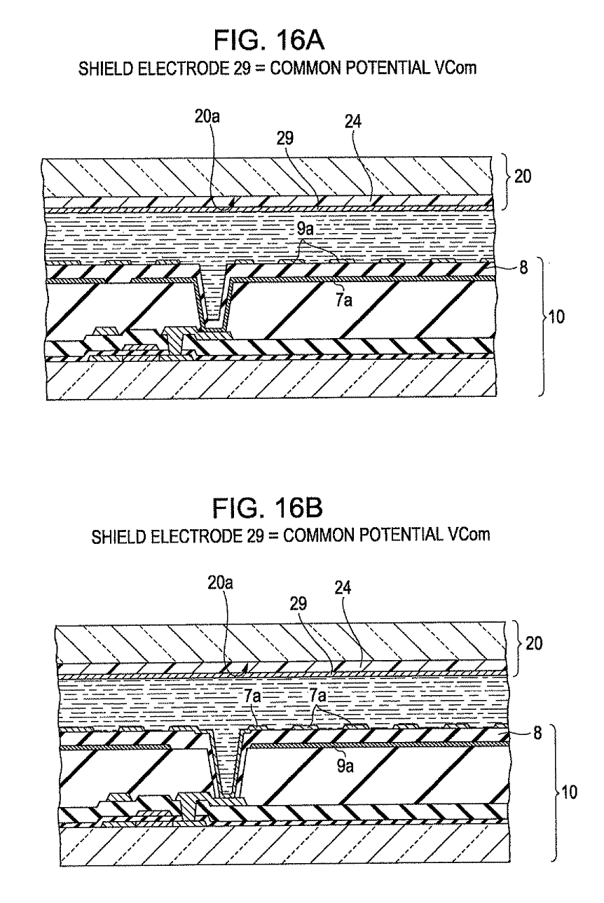

Configuration Example 3: Comparative Example (see FIG. 16A);

Configuration Example 4: Sixth Embodiment of the invention;

Configuration Example 5: Second Embodiment of the invention;

Configuration Example 6: First Embodiment of the invention;

Configuration Example 7: Comparative Example (see FIG. 16B); and

Configuration Example 8: Fifth Embodiment of the invention

Hereinafter, each embodiment of the invention will be described with reference to Table 1 and FIG. 1.

### First Embodiment

### Overall Configuration

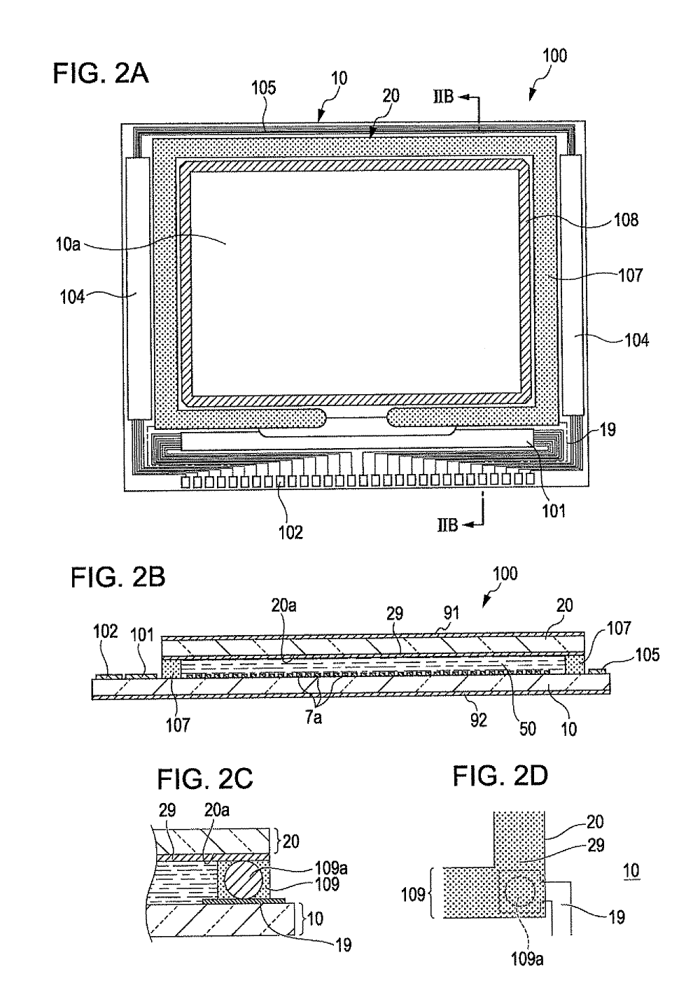

FIG. 2A is a plan view illustrating the liquid crystal device to which the invention is applied and constituent elements formed in the liquid crystal device when viewed from a side of a counter substrate, FIG. 2B is a sectional view taken along the line IIB-IIB of FIG. 2A, FIG. 2C is an expanded sectional view illustrating an electric conductive configuration between the shield electrode of the counter substrate and wires of an element substrate, and FIG. 2D is a plan view illustrating the electric conductive configuration.

In FIGS. 2A and 2B, a liquid crystal device 100 according to this embodiment is a transmissive active matrix type liquid crystal device. An element substrate 10 and a counter substrate 20 are attached each other by a sealing member 107 with a predetermined gap spaced therebetween. The counter substrate 20 has the almost same contour as that of the sealing member 107, and liquid crystal 50 which is homogeneously aligned is interposed in an area partitioned by the sealing member 107 between the element substrate 10 and the counter substrate 20. The liquid crystal 50 is a liquid crystal composition which exhibits positive dielectric anisotropy in which dielectric anisotropy in an alignment direction is larger than dielectric anisotropy in a normal line direction and exhibits a nematic phase in a large temperature range.

In the element substrate 10, a data line driving circuit 101 and mounted terminals 102 are disposed along one side of the element substrate 10 in an area outside the sealing member 107, and scanning line driving circuits 104 are disposed along two sides adjacent to the side in which the mounted terminals 102 are disposed. A plurality of wires 105 connecting between the scanning line driving circuits 104 disposed on both sides of an image display area 10a are disposed along the one remaining side of the element substrate 10. Additionally, a pre-charge circuit, an inspection circuit, a peripheral circuit, or the like may be provided below a frame 108.

Even though described in detail below, light-transmitting pixel electrodes 7a formed of an ITO (Indium Tin Oxide) film, an IZO (Indium Zinc Oxide) film, or the like are formed in a matrix shape on the element substrate 10. On the other hand, in the counter substrate 20, the frame 108 (which is not shown in FIG. 2B) formed of a light-shielding material is formed in an area inside the sealing member 107, and an inside area of the frame 108 is configured as the image display area 10a. In the counter substrate 20, light-shielding films (not shown) which are also called a black matrix or a black stripe are formed in areas opposed to vertical and horizontal boundary areas of the pixel electrodes 7a of the element substrate 10, and color filters (which are not shown in FIG. 2B) of predetermined colors are formed in areas opposed to the pixel electrodes 7a.

The liquid crystal device 100 according to this embodiment drives the liquid crystal 50 in an FFS mode. Accordingly, a common electrode (not shown) in addition to the pixel electrodes 7a is provided in the element substrate 10. In addition, in the counter substrate 20, all electrodes such as the pixel electrodes 7a and the common electrode which drive liquid crystal are not formed on the inner surface 20a opposed to the element substrate 10. For that reason, it is easy for static electricity to intrude from a side of the counter substrate 20. Therefore, in the liquid crystal device 100 according to this embodiment, even though described in detail below, a light-transmitting shield electrode 29 formed of an electric conductive film such as an ITO film or an IZO film is formed across the inner surface 20a opposed to the element substrate 10 in the counter substrate 20.

In some cases, a predetermined potential is applied to the shield electrode 29 as well as a case where the shield electrode 29 becomes a potentially floating state. As shown in FIGS. 2C and 2D, a part or the whole of the sealing member 107 is configured as an inter-substrate conductive member 109 containing electric conductive particles 109a upon applying the predetermined potential to the shield electrode 29, and electrically connect the shield electrode 29 formed on the inner surface 20a of the counter substrate 20 to a wire 19 formed in the element substrate 10. On the other hand, when the shield electrode 29 is in the potentially floating state, electric conductivity between the substrates is omitted.

In the liquid crystal device 100 according to the invention, as shown in FIG. 2B, the counter substrate 20 is disposed on a side where displaying light is emitted and a backlight unit (not shown) is disposed opposite the counter substrate 20 in the element substrate 10. Polarizing plates 91 and 92 or optical members such as a phase difference plate are disposed in the counter substrate 20 and the element substrate 10, respectively. The liquid crystal device 100 is configured as a reflective liquid crystal device or a transflective liquid crystal device. In the transflective liquid crystal device, a phase difference layer may be formed in a reflective display area of a surface opposed to the element substrate 10 in the counter substrate 20.

### Detailed Configuration of Liquid Crystal Device 100

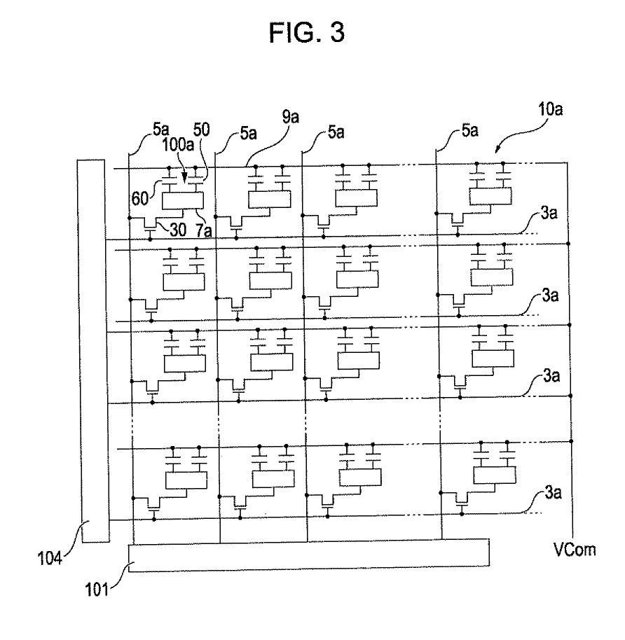

The configurations of the liquid crystal device 100 according to the invention and the element substrate used for the liquid crystal device will be described with reference to FIG. 3. FIG. 3 is an equivalent circuit diagram illustrating an electric configuration of the image display area 10a of the element substrate 10 used for the liquid crystal device 100 according to the invention.

As shown in FIG. 3, a plurality of pixels 100a are formed in a matrix shape in the image display area 10a of the liquid crystal device 100. In each of the plurality of pixels 100a, a pixel electrode 7a and a thin film transistor 30 (pixel transistor) which controls the pixel electrode 7a are formed, and a data line 5a supplying a data signal (image signal) in a line order is electrically connected to a source of the thin film transistor 30. A scanning line 3a is electrically connected to a gate of the thin film transistor 30. A scanning signal is applied to the scanning lines 3a in a line order at predetermined timing. The pixel electrode 7a is electrically connected to a drain of the thin film transistor 30 and writes the data signal supplied from the data line 5a to each of the pixels 100a by turning on the thin film transistor 30 only for a predetermined period of time. In this way, through the pixel electrode 7a, a pixel signal having a predetermined level which is written to the liquid crystal 50 shown in FIG. 2B is maintained for a predetermined period of time between the pixel electrode 7a and the common electrode 9a formed in the element substrate 10. Here, each of holding capacitors 60 is provided between the pixel electrode 7a and the common electrode 9a. In addition, a voltage of the pixel electrode 7a is maintained for time longer than application time of a source voltage by a three-digit number, for example. In this way, an electric charge maintaining characteristic is improved, thereby realizing the liquid crystal device 100 capable of obtaining a high contrast ratio.

In FIG. 3, the common electrode 9a is illustrated like a wire. However, the common electrode 9a is formed on the entire surface or the substantially entire surface of the image display area 10a of the element substrate 10 and maintained with the common potential VCom. In addition, the common electrode 9a may be formed across the plurality of pixels 100a or in each of the plurality of pixels 100a. In either case, a common potential is applied.

### Detailed Configuration of Each Pixel

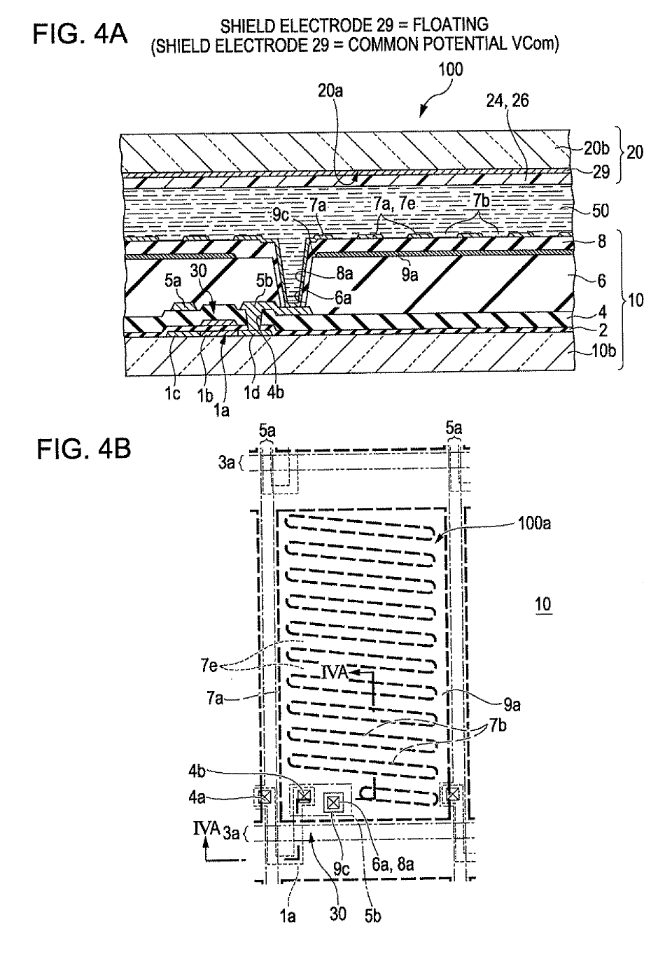

FIGS. 4A and 4B are a sectional view illustrating one pixel in the liquid crystal device 100 and a plan view illustrating the pixels adjacent to each other in the element substrate 10 according to the first embodiment of the invention, respectively. FIG. 4A is the sectional view illustrating the liquid crystal device 100 at a location corresponding to the line IVA-IVA of FIG. 4B. In FIG. 4B, the pixel electrode 7a is indicated by a long dotted line, the data line 5a and a thin film formed along with the data line 5a are indicated by a one-dotted chain line, the scanning line 3a is indicated by a two-dotted chain line, and a part partially removed in the common electrode 9a is indicated by a solid line.

As shown in FIGS. 4A and 4B, the light-transmitting pixel electrode 7a (which is an area surrounded by the long dotted line) is formed in every pixel 100a in the element substrate 10. Each of the data lines 5a (which is an area indicated by the one-dotted chain line) and each of the scanning lines 3a (which is an area indicated by the two-dotted chain line) extend along the vertical and horizontal boundary area of each of the pixel electrodes 7a. The light-transmitting common electrode 9a is formed on the substantially entire surface of the image display area 10a of the element substrate 10. The pixel electrodes 7a and the common electrode 9a are all formed of an ITO film.

In this embodiment, the common electrode 9a is configured as a lower electrode and the pixel electrode 7a is configured as an upper electrode. Therefore, in the pixel electrode 7a on the upper side, a plurality of slits 7b which generate a fringe electric field are formed to be parallel to each other and portions interposed between the plurality of slits 7b are configured as a plurality of electrode portions 7e having a line shape. Here, the width of each slit 7b is in the range of 3 to 10 μm, for example, and the width of the electrode portion 7e having the line shape is in the range of 2 to 8 μm. The slits 7b extend at 5° with respect to the scanning line 3a.

A base substrate of the element substrate 10 shown in FIG. 4A includes a light-transmitting substrate 10b such as a quartz substrate or a heat-resistant glass substrate. A base substrate of the counter substrate 20 includes a light-transmitting substrate 20b such as a quartz substrate or a heat-resistant glass substrate. In this embodiment, the glass substrate is used for both the light-transmitting substrates 10b and 20b. In the element substrate 10, a ground protective film (not shown) formed of a silicon oxide film or the like is formed on a surface of the light-transmitting substrate 10b, and the thin film transistor 30 having a top gate structure is formed at a location corresponding to each of the pixel electrodes 7a on the surface.

As shown in FIGS. 4A and 4B, the thin film transistor 30 has a configuration in which a channel area 1b, a source area 1c, and a drain area 1d are formed in a semiconductor layer 1a having an island shape and may be formed so as to have an LDD (Lightly Doped Drain) structure containing low concentration areas on both sides of the channel area 1b. In this embodiment, the semiconductor layer 1a is a poly-silicon film formed by forming an amorphous silicon film on the element substrate 10 and then subjecting the amorphous silicon film to poly-crystallization by laser annealing, lamp annealing, and the like. A gate insulating film 2 formed of a silicon oxide film and a silicon nitride film or a laminate film thereof is provided on the semiconductor layer 1a, a part of the scanning line 3a is overlapped as a gate electrode on the gate insulating film 2. In this embodiment, the semiconductor layer 1a is bent in a U-shape and has a twin gate structure in which gate electrodes are formed at two locations in a channel direction.

An inter-layer insulating film 4 formed of a silicon oxide film and a silicon nitride film or a laminate film thereof is provided above the gate electrodes (the scanning line 3a). The data line 5a is formed on a surface of the inter-layer insulating film 4. The data line 5a is electrically connected to the source area located on the closest side of the data line 5a with a contact hole 4a formed in the inter-layer insulating film 4 interposed therebetween. Each of drain electrodes 5b is formed on a surface of the inter-layer insulating film 4. The drain electrode 5b is an electric conductive film which is simultaneously formed along with the data line 5a. The inter-layer insulating film 6 is provided above the data line 5a and the drain electrode 5b. In this embodiment, the inter-layer insulating film 6 is configured as a flattened film formed of a thick photosensitive resin having a thickness in the range of 1.5 to 2.0 μm.

The common electrode 9a formed of an ITO film is formed on the surface of the inter-layer insulating film 6. A notched portion 9c is formed at a location overlapped with the drain electrode 5b in the common electrode 9a. An insulating film 8 formed of a silicon oxide film and a silicon nitride film or a laminate film thereof is formed on a surface of the common electrode 9a. The pixel electrode 7a formed of an ITO film is formed in an island shape above the insulating film 8. A contact hole 6a is formed in the inter-layer insulating film 6 and a contact hole 8a is formed within the contact hole 6a in the insulating film 8. With such a configuration, the pixel electrode 7a is electrically connected to the drain electrode 5b in a bottom portion of the contact holes 6a and 8a. The drain electrode 5b is electrically connected to a drain area 1d through a contact hole 4b formed in the inter-layer insulating film 4 and the gate insulating film 2. An inter-layer insulating film 6 as a flattened film is provided below the pixel electrode 7a and the vicinity of the data line 5a is also flattened. With such a configuration, the end of the pixel electrode 7a is located in the vicinity of the data line 5a.

The slits 7b which generate the fringe electric field are formed in each of the pixel electrodes 7a, and the fringe electric field is generated between the pixel electrode 7a and the common electrode 9a through the slits 7b. In addition, the common electrode 9a and the pixel electrode 7a are opposed to each other with the insulating film 8 interposed therebetween. A holding element using the insulating film 8 as a dielectric film between the pixel electrode 7a and the common electrode 9a is provided, and the holding element is used as the holding capacitor 60 shown in FIG. 3.

### Configuration of Counter Substrate 20 and the Like

On the other hand, in the counter substrate 20, the shield electrode 29 formed of an ITO film is provided on the entire inner surface 20a opposed to the element substrate 10. The color filters 24 corresponding to colors are provided on the shield electrode 29. The color filters 24 are formed of a resin layer 26 containing a predetermined color material. In this embodiment, the color filter 24 has a thickness of 2 μm or more and permittivity of 6 or less. In this embodiment, the shield electrode 29 is in the potentially floating state. An alignment film (not shown) is provided in the element substrate 10 and the counter substrate 20. The alignment film provided in the counter substrate 20 is subjected to rubbing in a direction parallel to the scanning line 3a and the alignment film provided in the element substrate 10 is subjected to rubbing in a direction reverse to the rubbing direction of the alignment film of the counter substrate 20. Accordingly, the liquid crystal 50 is capable of being homogeneously aligned. Here, the slits 7b formed in each of the pixel electrodes 7a of the element substrate 10 are formed in parallel to each other and extend so as to have a 5° inclination with respect to the scanning line 3a. Accordingly, the alignment film is subjected to the rubbing at 5° in a direction in which the slits 7b extend. The polarizing plates 91 and 92 are disposed so that polarizing axes thereof are perpendicular to each other. The polarizing axis of the polarizing plate 91 of the counter substrate 20 is perpendicular to the rubbing direction of the alignment film, and the polarizing axis of the polarizing plate 92 of the element substrate 10 is parallel to the rubbing direction of the alignment film.

### Main Advantages of this Embodiment

In the liquid crystal device 100 having the above-described configuration, an electrode driving the liquid crystal 50 is not formed in the counter substrate 20, but the shield electrode 29 is formed. Accordingly, it is difficult for electrification caused due to static electricity to occur in the counter substrate 20. Even though the electrification caused due to static electricity occurs, the alignment of the liquid crystal 50 is not disturbed. Moreover, since the shield electrode 29 is provided on the inner surface 20a of the counter substrate 20, it is possible to form the shield electrode 29 in a substrate state before assembly of a liquid crystal panel.

In this embodiment, the shield electrode 29 formed of an ITO film and the color filters 24 (resin layer 26) are stacked in order on the inner surface 20a opposed to the element substrate 10 in the counter substrate 20, and the shield electrode 29 is provided below the color filters 24. Moreover, the color filters 24 are formed of the resin layer 26 having low permittivity and a thick film. The shield electrode 29 is in the potentially floating state. With such a configuration, the alignment of the liquid crystal 50 is not disturbed by the shield electrode 29, even when the shield electrode 29 is provided on the inner surface 20a opposed to the element substrate 10 in the counter substrate 20. Therefore, very high transmissivity is achieved, as indicated by the line L6 (Com LOWER CF LOWER Floating) in FIG. 1 and “a Tmax Ref ratio” of 89.3% in Table 1. Accordingly, it is possible to realize a high quality image such as a high contrast image, even when the shield electrode 29 shielding static electricity is provided on the inner surface 20a opposed to the element substrate 10 in the counter substrate 20.

### Second Embodiment

The shield electrode 29 is in the potentially floating state in the first embodiment. However, in this embodiment, the common potential VCom is applied to the shield electrode 29, as in the common electrode 9a, by electrically connecting the shield electrode 29 to the wire 19 formed by the common electrode 9a of the element substrate 10 or the wire 19 extending from the common electrode 9a by use of electric conductivity between the substrates shown in FIGS. 2C and 2D. Since the other configuration is the same as that in the first embodiment, description is omitted. In the liquid crystal device 100 according to this embodiment, the shield electrode 29 is formed in the counter substrate 20. Accordingly, it is difficult for electrification caused due to static electricity to occur in the counter substrate 20. Even though the electrification caused due to static electricity occurs, the alignment of the liquid crystal 50 is not disturbed.

In this embodiment, the shield electrode 29 formed of an ITO film and the color filters 24 (resin layer 26) are stacked in order on the entire inner surface 20a opposed to the element substrate 10. The shield electrode 29 is provided below the color filters 24. Moreover, each of the color filters 24 is formed of the resin layer 26 having low permittivity and a thick film. The common potential VCom is applied to the shield electrode 29. With such a configuration, the alignment of the liquid crystal 50 is not disturbed by the shield electrode 29, even when the shield electrode 29 is provided on the inner surface 20a opposed to the element substrate 10 in the counter substrate 20. Therefore, very high transmissivity is achieved, as indicated by the line L5 (Com LOWER CF LOWER VCom) in FIG. 1 and “a Tmax Ref ratio” of 89.3% in Table 1. Accordingly, it is possible to realize a high quality image such as a high contrast image, even when the shield electrode 29 shielding static electricity is provided on the inner surface 20a opposed to the element substrate 10 in the counter substrate 20.

### Third Embodiment

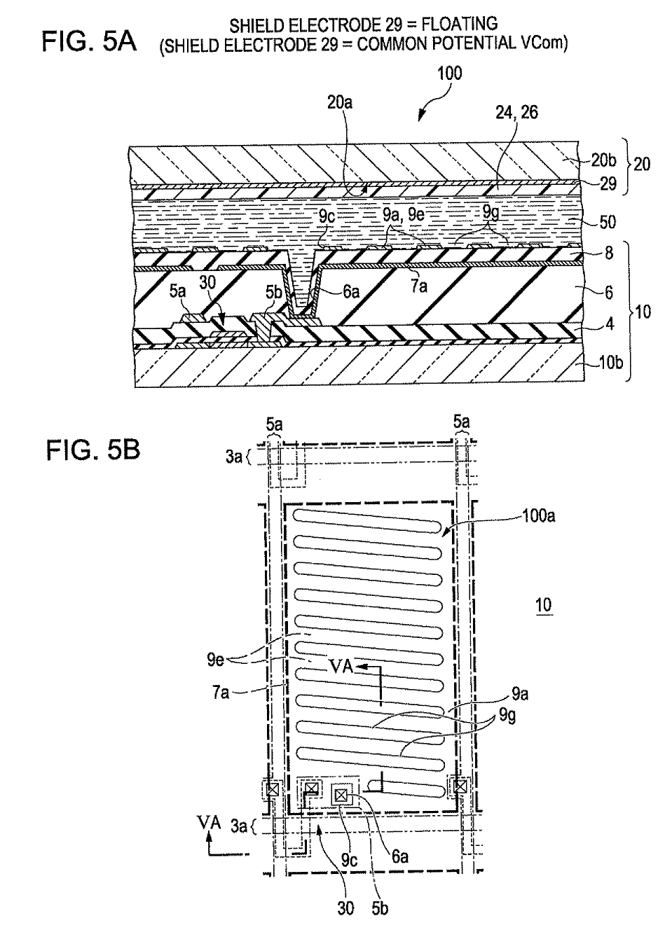

FIGS. 5A and 5B are a sectional view illustrating one pixel in the liquid crystal device 100 and a plan view illustrating the pixels adjacent to each other in the element substrate 10 according to a third embodiment of the invention, respectively. FIG. 5A is the sectional view illustrating the liquid crystal device 100 at a location corresponding to the line IVA-IVA of FIG. 4B described in the first embodiment. Since a basic configuration according to this embodiment is the same as that according to the first embodiment, the same reference numerals are given to the same constituent elements and description is omitted.

In the first and second embodiments, the pixel electrode 7a is provided above the insulating film 8 and the common electrode 9a is provided below the insulating film 8 in the element substrate 10. However, as shown in FIGS. 5A and 5B, in the liquid crystal device 100 according to this embodiment, the common electrode 9a formed of an ITO film is formed as an upper electrode above the insulating film 8 and the pixel electrode 7a formed of an ITO film is formed as a lower electrode below the insulating film 8 in the element substrate 10. With such a configuration, the pixel electrode 7a is electrically connected to the drain electrode 5b through the contact hole 6a of the inter-layer insulating film 6. In addition, in the common electrode 9a, the notched portion 9c is formed in an area where the contact hole 6a is formed.

In the liquid crystal device 100 having the above-described configuration, the FFS mode used in the first embodiment is also used. A plurality of slits 9g which generate the fringe electric field are provided in the common electrode 9a on the upper side, and portions interposed between the plurality of slits 9g are configured as a plurality of electrode portions 9e having a line shape. Here, a width of the slits 9g is in the range of 3 to 10 μm, for example, and the width of the electrode portion 9e having the line shape is in the range of 2 to 8 μm, for example.

On the other hand, in the counter substrate 20, the shield electrode 29 formed of an ITO film is provided on the entire inner surface 20a opposed to the element substrate 10, and the color filters 24 corresponding to colors are provided on the shield electrode 29, as in the first embodiment. Each of the color filters 24 is formed of the resin layer 26 containing a predetermined color material. In this embodiment, the color filter 24 also has a thickness of 2 μm or more and permittivity of 6 or less, as in the first embodiment. In this embodiment, the shield electrode 29 is in the potentially floating state.

In the liquid crystal device 100 having the above-described configuration, an electrode which drives the liquid crystal is not formed in the counter electrode 20, but the shield electrode 29 is formed. Accordingly, it is difficult for electrification caused due to static electricity to occur in the counter substrate 20. Even though the electrification caused due to static electricity occurs, the alignment of the liquid crystal 50 is not disturbed.

In this embodiment, the shield electrode 29 formed of an ITO film and the color filters 24 (resin layer 26) are stacked in order on the inner surface 20a opposed to the element substrate 10 in the counter substrate 20. The shield electrode 29 is provided below the color filters 24. Moreover, the color filters 24 are formed of the resin layer 26 having low permittivity and a thick film. The shield electrode 29 is in the potentially floating state. With such a configuration, the alignment of the liquid crystal 50 is not disturbed by the shield electrode 29, even when the shield electrode 29 is provided on the inner surface 20a opposed to the element substrate 10 in the counter substrate 20. Therefore, even in comparison to the result of the first embodiment, very high transmissivity is achieved, as indicated by the line L2 (Com UPPER CF LOWER Floating) in FIG. 1 and “a Tmax Ref ratio” of 98.0% in Table 1. Accordingly, it is possible to realize a high quality image such as a high contrast image, even when the shield electrode 29 shielding static electricity is provided on the inner surface 20a opposed to the element substrate 10 in the counter substrate 20.

### Fourth Embodiment

The shield electrode 29 is in the potentially floating state in the third embodiment. However, in this embodiment, the common potential VCom is applied to the shield electrode 29, as in the common electrode 9a, by electrically connecting the shield electrode 29 to the wire 19 formed by the common electrode 9a of the element substrate 10 or the wire 19 extending from the common electrode 9a by use of electric conductivity between the substrates shown in FIGS. 2C and 2D. Since the other configuration is the same as that in the second embodiment, description is omitted. In the liquid crystal device 100 according to this embodiment, the shield electrode 29 is provided in the counter substrate 20. Accordingly, it is difficult for electrification caused due to static electricity to occur in the counter substrate 20. Even though the electrification caused due to static electricity occurs, the alignment of the liquid crystal 50 is not disturbed.

In this embodiment, the shield electrode 29 formed of an ITO film and the color filters 24 (resin layer 26) are stacked in order on the entire inner surface 20a opposed to the element substrate 10 in the counter substrate 20. The shield electrode 29 is provided below the color filters 24. Moreover, the color filters 24 are formed of the resin layer 26 having low permittivity and a thick film. The common potential VCom is applied to shield electrode 29. With such a configuration, the alignment of the liquid crystal 50 is not disturbed by the shield electrode 29, even when the shield electrode 29 is provided on the inner surface 20a opposed to the element substrate 10 in the counter substrate 20. Therefore, even in comparison to the result of the second embodiment, very high transmissivity is achieved, as indicated by the line L1 (Com UPPER CF LOWER VCom) in FIG. 1 and “a Tmax Ref ratio” of 98.0% in Table 1. Accordingly, it is possible to realize a high quality image such as a high contrast image, even when the shield electrode 29 shielding static electricity is provided on the inner surface 20a opposed to the element substrate 10 in the counter substrate 20.

### Fifth Embodiment

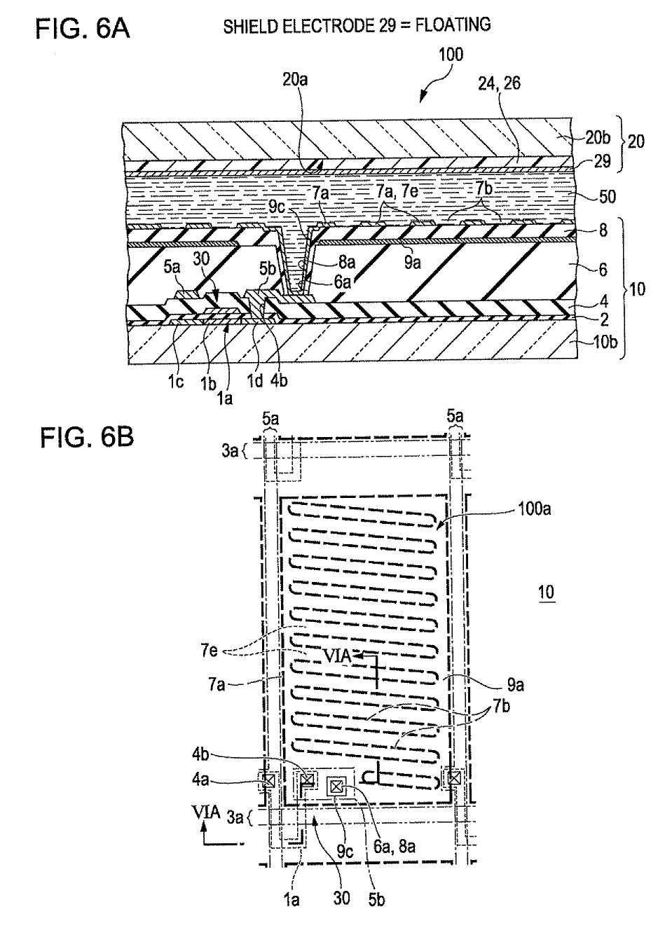

FIGS. 6A and 6B are a sectional view illustrating one pixel in the liquid crystal device 100 and a plan view illustrating the pixels adjacent to each other in the element substrate 10 according to a fifth embodiment of the invention, respectively. FIG. 6A is the sectional view illustrating the liquid crystal device 100 at a location corresponding to the line IVA-IVA of FIG. 4B described in the first embodiment. Since a basic configuration according to this embodiment is the same as that according to the first embodiment, the same reference numerals are given to the same constituent elements and description is omitted.

As shown in FIGS. 6A and 6B, in this embodiment, the common electrode 9a is provided below the insulating film 8 and the pixel electrode 7a is provided above the insulating film 8, as in the first embodiment.

On the other hand, in the counter substrate 20, the shield electrode 29 formed of an ITO film is provided on the entire inner surface 20a opposed to the element substrate 10 as in the first embodiment. However, in this embodiment, unlike the first embodiment, the color filters 24 (resin layer 26) corresponding to colors are provided below the shield electrode 29 and the shield electrode 29 is provided above the color filters 24 (resin layer 26). Here, the shield electrode 29 is in the potentially floating state.

In the liquid crystal device 100 having the above-described configuration, an electrode which drives the liquid crystal is not formed in the counter electrode 20, but the shield electrode 29 is formed. Accordingly, it is difficult for electrification caused due to static electricity to occur in the counter substrate 20. Even though the electrification caused due to static electricity occurs, the alignment of the liquid crystal 50 is not disturbed.

In this embodiment, the shield electrode 29 is stacked above the color filters 24 (resin layer 26) on a side of the entire inner surface 20a opposed to the element substrate 10. The shield electrode 29 is in the potentially floating state. With such a configuration, the alignment of the liquid crystal 50 is not disturbed by the shield electrode 29, even when the shield electrode 29 is provided on the side of the inner surface 20a opposed to the element substrate 10 in the counter substrate 20. Therefore, even in comparison to the result of the first embodiment, very high transmissivity is achieved, as indicated by the line L8 (Com LOWER CF UPPER Floating) in FIG. 1 and “a Tmax Ref ratio” of 96.0% in Table 1. Accordingly, it is possible to realize a high quality image such as a high contrast image, even when the shield electrode 29 shielding static electricity is provided on the side of the inner surface 20a opposed to the element substrate 10 in the counter substrate 20.

### Sixth Embodiment

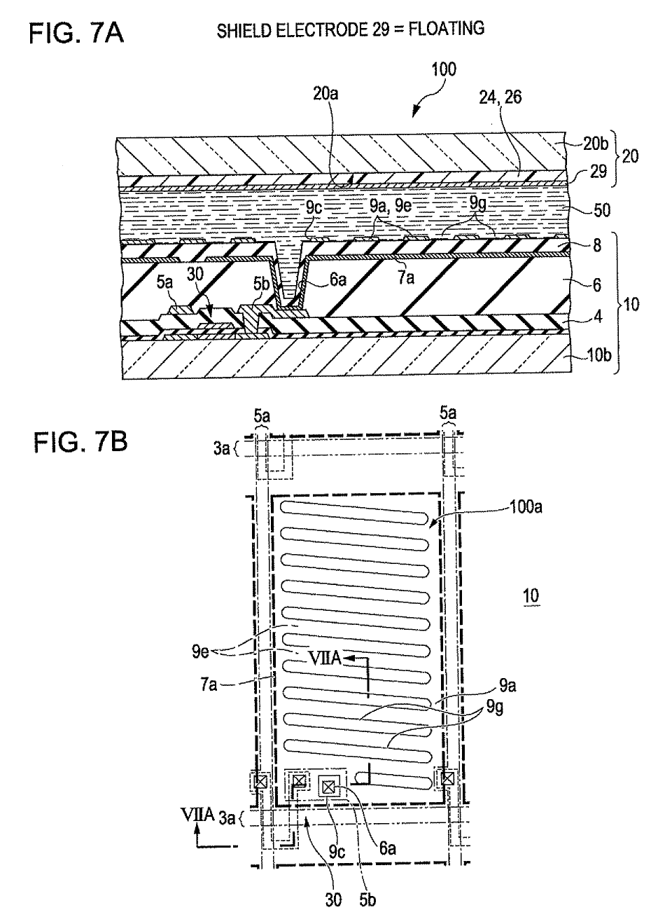

FIGS. 7A and 7B are a sectional view illustrating one pixel in the liquid crystal device 100 and a plan view illustrating the pixels adjacent to each other in the element substrate 10 according to a sixth embodiment of the invention, respectively. FIG. 7A is the sectional view illustrating the liquid crystal device 100 at a location corresponding to the line IVA-IVA of FIG. 4B described in the first embodiment. Since a basic configuration according to this embodiment is the same as that according to the first embodiment, the same reference numerals are given to the same constituent elements and description is omitted.

As shown in FIGS. 7A and 7B, in this embodiment, the pixel electrode 7a is provided below the insulating film 8 and the common electrode 9a is provided above the insulating film 8, as in the third embodiment.

On the other hand, in the counter substrate 20, the shield electrode 29 formed of an ITO film is provided on the entire inner surface 20a opposed to the element substrate 10 as in the third embodiment. However, in this embodiment, unlike the third embodiment, the color filters 24 (resin layer 26) corresponding to colors are provided below the shield electrode 29 and the shield electrode 29 is provided above the color filters 24 (resin layer 26). In this embodiment, the shield electrode 29 is in the potentially floating state.

In the liquid crystal device 100 having the above-described configuration, an electrode which drives the liquid crystal is not formed in the counter electrode 20, but the shield electrode 29 is formed. Accordingly, it is difficult for electrification caused due to static electricity to occur in the counter substrate 20. Even though the electrification caused due to static electricity occurs, the alignment of the liquid crystal 50 is not disturbed.

In this embodiment, the shield electrode 29 is stacked above the color filters 24 (resin layer 26) on the side of the entire inner surface 20a opposed to the element substrate 10. The shield electrode 29 is in the potentially floating state. With such a configuration, the alignment of the liquid crystal 50 is not disturbed by the shield electrode 29, even when the shield electrode 29 is provided on the side of the inner surface 20a opposed to the element substrate 10 in the counter substrate 20. Therefore, the same very high transmissivity as that in the third embodiment is achieved, as indicated by the line L4 (Com LOWER CF UPPER VCom) in FIG. 1 and “a Tmax Ref ratio” of 97.0% in Table 1. Accordingly, it is possible to realize a high quality image such as a high contrast image, even when the shield electrode 29 shielding static electricity is provided on the side of the inner surface 20a opposed to the element substrate 10 in the counter substrate 20.

### Modified Example of First to Fourth Embodiments

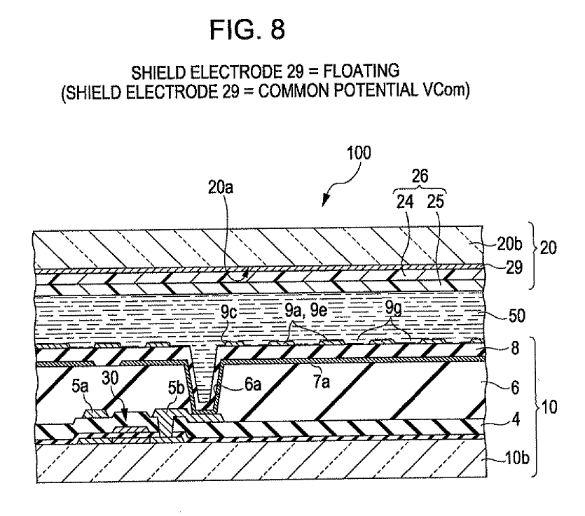

FIG. 8 is a sectional view illustrating one pixel in the liquid crystal device 100 according to a modified example of the first to fourth embodiments of the invention.

In the first to fourth embodiments, the shield electrode 29 and the color filters 24 are stacked on the inner surface 20a of the counter substrate 20 and only the color filters 24 are configured as the resin layer 26 covering the shield electrode 29. However, as shown in FIG. 8, in this embodiment, the shield electrode 29, the color filters 24, and an overcoat layer 25 (which is a protective layer for the color filters 24) formed of a resin layer are provided on the inner surface 20a of the counter substrate 20, and the color filters 24 and the overcoat layer 25 are used as the resin layer 26. Even with such a configuration, it is possible to prevent the shield electrode 29 from affecting the alignment of the liquid crystal 50. The configuration shown in FIG. 8 is a modified example of the configuration of the resin layer 26 shown in FIG. 5 mainly according to the third embodiment. In the first, second, and fourth embodiments, the resin layer 26 is constituted by the color filters 24 and the overcoat layer 25.

### Configuration of Resin Layer 26 in First to Fourth Embodiments

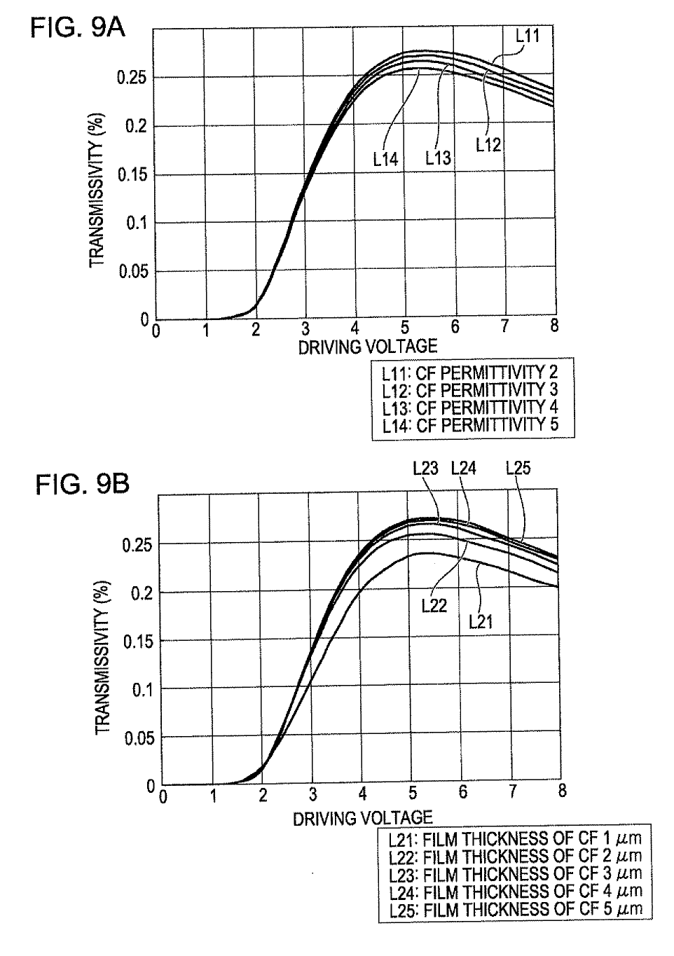

FIGS. 9A and 9B are graphs illustrating relations between a driving voltage and transmissivity for liquid crystal in the liquid crystal device 100 according to the first to fourth embodiments of the invention, when the film thickness and the permittivity of the resin layer 26 are varied.

In the first to fourth embodiments of the invention, the resin layer 26 (color filters 24) has the thickness of 2 μm or more and the permissivity of 6 or less. However, when the thickness of the resin layer 26 is set to 2 μm, for example, and the permissivity of the resin layer 26 varies in the range of 2 to 5, the results are shown by lines L11 to L14 in FIG. 9A. That is, since the resin layer having lower permittivity is capable of preventing the electric field from being disturbed, the transmissivity is improved. Accordingly, it is preferable that the permittivity of the resin layer 26 is lower, but it is also sufficient that the resin layer 26 has the permittivity of 6 or less in consideration of kinds of a usable material or a level of the transmissivity.

When the permittivity of the resin layer 26 is set to 3, for example, and the thickness of the resin layer 26 is varied in the range of 1 to 5 μm, the results are shown by lines L21 to L25 in FIG. 9B. That is, it is preferable that the resin layer 26 is thick. However, when the thickness of the resin layer 26 is 2 μm or more, a shielding effect of the shield electrode is high, thereby preventing the electric field from being disturbed. Accordingly, in consideration of obtaining the substantially same transmissivity or allowing deterioration in the transmissivity to be very small, a sufficient thickness of the resin layer 26 is 2 μm or more.

### Example Using Line Inversion in Second and Fourth Embodiments

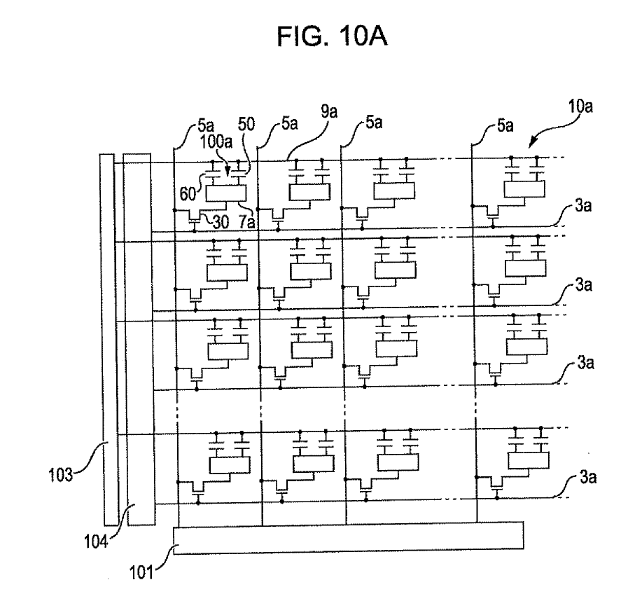

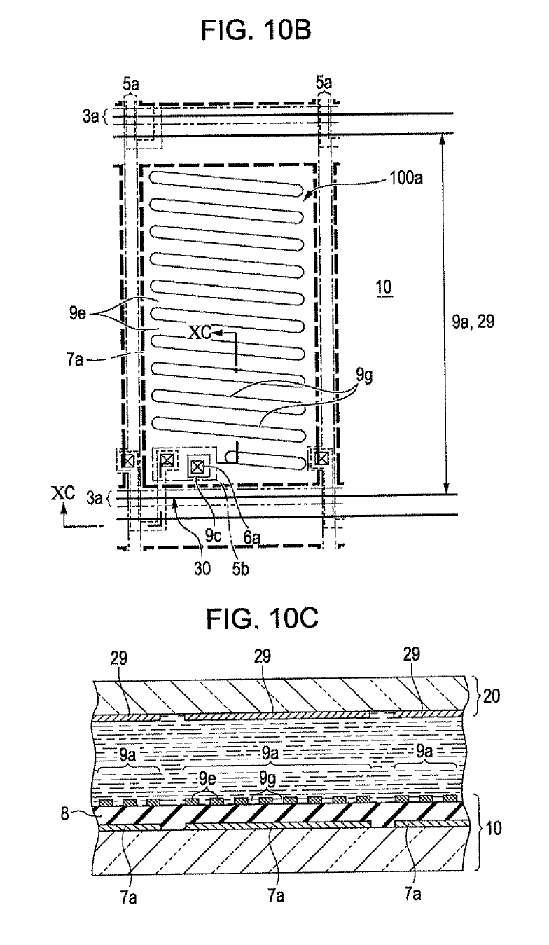

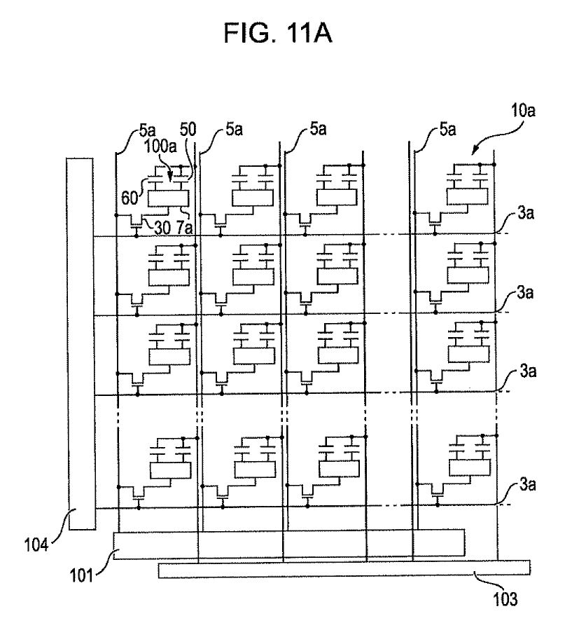

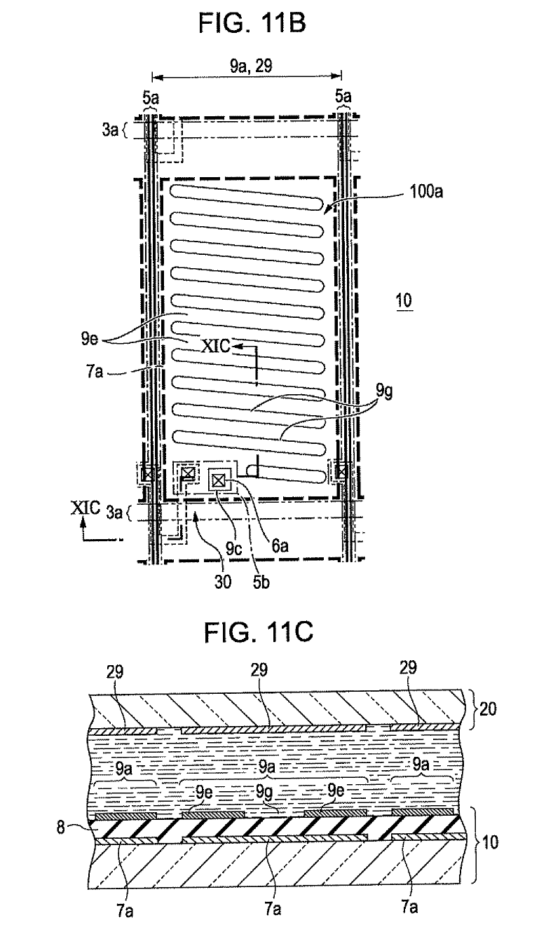

FIGS. 10A, 10B, and 10C are a block diagram when horizontal line inversion is performed in the liquid crystal device 100 according to the second and fourth embodiments of the invention, a plan view illustrating the pixel configuration, and a schematic explanatory diagram illustrating the cross-section of the pixels, respectively. FIG. 10C shows that the pixels are cut in a direction in which the data lines extend. FIGS. 11A, 11B, and 11C are a block diagram when vertical line inversion is performed in the liquid crystal device 100 according to the second and fourth embodiments of the invention, a plan view illustrating the pixel configuration, and a schematic explanatory diagram illustrating the cross-section of the pixels, respectively. FIG. 11C shows that the pixels are cut in a direction in which the scanning lines extend.

As shown in FIGS. 10A, 10B, and 10C, the horizontal line inversion is performed in the liquid crystal device 100 according to this embodiment in order to reduce power consumption. In this case, the common electrodes 9a extend in a strip shape along the plurality of pixels 100a arranged in a horizontal direction (which is a direction in which the scanning lines 3a extend) and are divided in a direction intersecting the extension direction. In addition, adjacent common electrodes 9a are driven with different potentials by a line inversion circuit 103.

In correspondence with this configuration, as shown in FIGS. 10B and 10C, the shield electrodes 29 formed on the inner surface of the counter substrate 20 also extend in a strip shape along the plurality of pixels 100a arranged in the horizontal direction and are divided in a direction in a direction perpendicular to the extension direction. Even with such a configuration, the common potential VCom is applied to the shield electrodes 29, as in the common electrodes 9a normally opposed to the shield electrodes 29, by electrically connecting between the shield electrodes 29 and the common electrodes 9a opposed to each other using electric conductivity between the substrates shown in FIGS. 2C and 2D.

As shown in FIGS. 11A, 11B and 11C, the vertical line inversion is performed in the liquid crystal device 100 according to this embodiment. In this case, the common electrodes 9a extend in a strip shape along the plurality of pixels 100a arranged in a vertical direction (which is a direction in which the data lines 6a extend) and are divided in a direction intersecting the extension direction. In addition, adjacent common electrodes 9a are driven with different potentials by the line inversion circuit 103.

In correspondence with this configuration, as shown in FIGS. 11B and 11C, the shield electrodes 29 formed in the inner surface of the counter substrate 20 also extend in a strip shape along the plurality of pixels 100a arranged in the vertical direction and are divided in a direction perpendicular to the extension direction. Even with such a configuration, the common potential VCom is applied to the shield electrodes 29, as in the common electrodes 9a normally opposed to the shield electrodes 29, by electrically connecting between the shield electrodes 29 and the common electrodes 9a opposed to each other using electric conductivity between the substrates shown in FIGS. 2C and 2D.

In FIGS. 10B, 10C, 11B, and 11C, the configuration shown in FIGS. 5A and 5B is modified, and the same is applied to the configuration shown in FIGS. 4A and 4B

### Voltage Applied to Shield Electrode 29 in Second and Fourth Embodiments

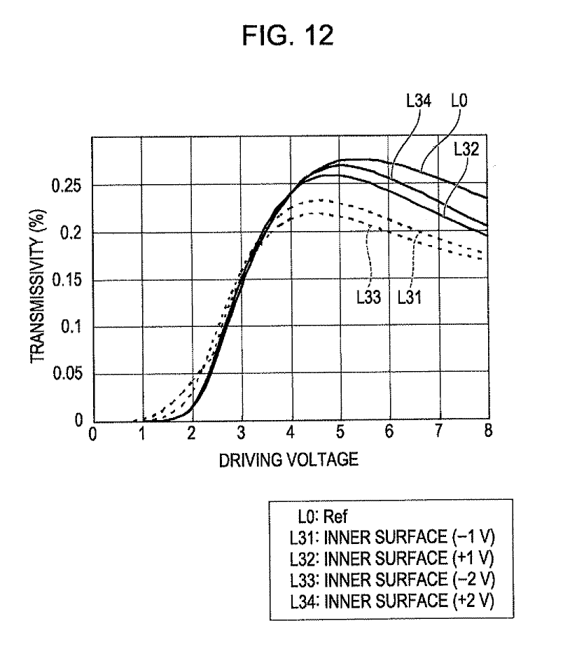

FIG. 12 is a graph obtained when a voltage applied to the shield electrode 29 is varied in the liquid crystal device 100 according to the second embodiment of the invention.

In the second embodiment, unlike the fourth embodiment, the pixel electrode 7a is provided above the common electrode 9a. It is difficult to apply the same potential as that of the pixel electrode 7a provided above the common electrode 9a to the shield electrode 29. Accordingly, in the second embodiment, it is preferable that the voltage applied to the shield electrode 29 upon applying the common potential VCom is a potential having the same polarity as that of the common potential VCom applied to the common electrode 9a opposed to the shield electrode 29 and an absolute value higher than that of the common potential VCom. That is, in FIG. 12, a characteristic obtained when the shield electrode 29 is not formed is shown by a line LO and characteristics obtained when potentials of −1 V, +1 V, −2 V, and +2 V are applied with respect to the common potential VCom are shown by lines L31, L32, L33, and L34, respectively. When theses results are compared, transmissivity is improved in order from −2 V, −1 V, +1 V, and +2 V with respect to the common potential VCom.

In the fourth embodiment, the voltage applied to the shield electrode 29 may be the potential having the same polarity as that of the common potential VCom applied to the common electrode 9a opposed to the shield electrode 29 and the absolute value higher than that of the common voltage.

### Other Embodiment

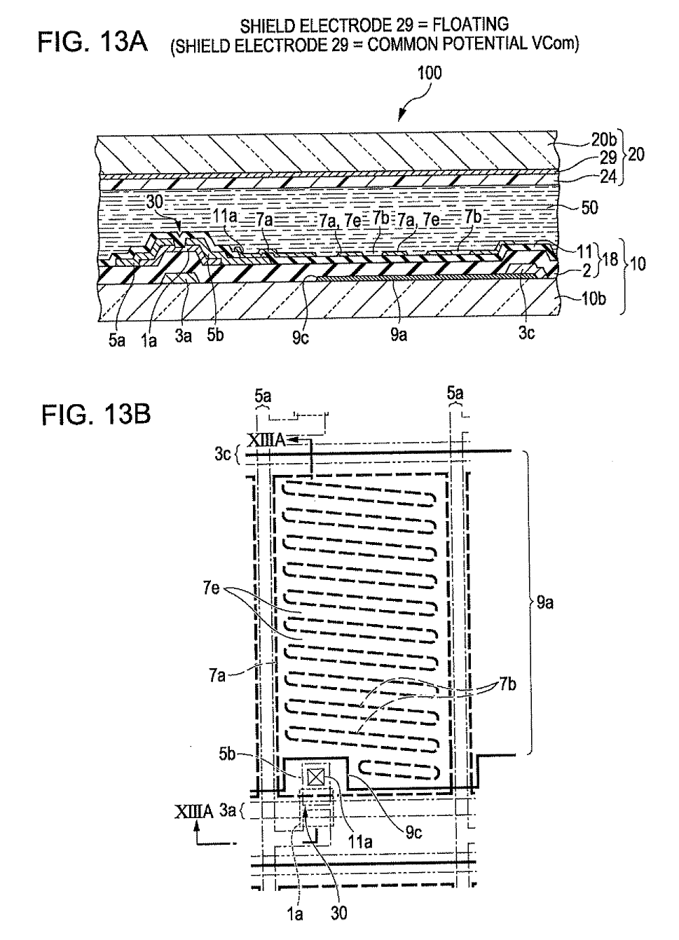

FIGS. 13A and 13B are a sectional view illustrating one pixel in the liquid crystal device 100 and a plan view illustrating the pixels adjacent to each other in the element substrate 10 according to another embodiment of the invention. FIG. 13A is the sectional view illustrating the liquid crystal device 100 at a location corresponding to the line XIIIA-XIIIA of FIG. 13B. In addition, since a basic configuration according to this embodiment is the same as that according to the first embodiment, the same reference numerals are given to common constituent elements, if possible, in order to allow the corresponding relation to be easily recognizable.

In the above-described embodiments, the thin film transistor 30 having the top gate structure is used as a pixel transistor. However, in this embodiment, as described below with reference to FIGS. 13A and 13B, a thin film transistor 30 having a bottom gate structure is used as the pixel transistor and the invention may be applied to the liquid crystal device 100 having this configuration. In the liquid crystal device 100 shown in FIGS. 13A and 13B, a light-transmitting pixel electrode 7a formed of an ITO film is provided in each of the pixels 100a on the element substrate 10. Each of the data lines 5a and each of the scanning lines 3a electrically connected to the thin film transistor 30 are formed along vertical and horizontal boundary area of the pixel electrode 7a. Common wires 3c are formed so as to be parallel to the scanning lines 3a. The common wire 3c is a wiring layer which is simultaneously formed along with the scanning line 3a. The light-transmitting common electrode 9a formed of an ITO film is formed below the common wire 3c so as to extend in a strip shape in the same direction as the extension direction of the scanning line 3a and the common wire 3c. The common wire 3c and the end of the common electrode 9a are electrically connected to each other. Accordingly, the common electrode 9a is formed so as to extend to the plurality of pixels 100a. However, the common electrode 9a is formed so as to extend with each of the pixels 100a, in some cases. In either case, the common electrode 9a is electrically connected to the common electrode 9a and a common potential is applied to the pixels 100a.

In this embodiment, the thin film transistor 30 has the bottom gate structure. In the thin film transistor 30, a gate electrode formed by a part of the scanning line 3a, a gate insulating film 2, a semiconductor layer 1a formed of an amorphous silicon film forming an active layer of the thin film transistor 30, and a contact layer (not shown) are stacked in order. In the semiconductor layer 1a, the data line 5a overlaps with an end of the source side with the contact layer interposed therebetween and a drain electrode 5b overlaps with an end of the drain side with the contact layer interposed therebetween. The data line 5a and the drain electrode 5b are formed of electric conductive films simultaneously formed. An insulating protective film 11 formed of a silicon nitride film or the like is formed on a surface of the data line 5a and the drain electrode 5b. The pixel electrode 7a formed of an ITO film is provided above the insulating protective film 11.

The plurality of slits 7b which generate the fringe electric field are formed to be parallel to each other in the pixel electrode 7a and electrode portions 7e having a line shape are formed between the slits 7b. A contact hole 11a is formed in an area overlapping with the drain electrode 5b in the insulating protective film 11. The pixel electrode 7a is electrically connected to the drain electrode 5b through the contact hole 11a.

In the element substrate 10, the common wire 3c is provided below the gate insulating film 2. The common electrode 9a formed of an ITO film is provided below the common wire 3c and an end of the common electrode 9a is electrically connected to the common wire 3c. The gate insulating film 2 and the insulating protective film 11 are formed in a surface of the common electrode 9a. Accordingly, an insulating film 18 formed by the gate insulating film 2 and the insulating protective film 11 is interposed between the common electrode 9a and the pixel electrode 7a. The holding capacitor 60 (see FIG. 3) using the insulating film 18 as a dielectric film is formed.

In this embodiment, amorphous silicon is used for the thin film transistor 30 in the configuration shown in FIGS. 5A and 5B. In addition, amorphous silicon may be used for the thin film transistor 30 in the configurations shown in FIGS. 4A, 4B, 6A, 6B, 7A, 7B, and 8.

### Mount Example to Electronic Apparatus

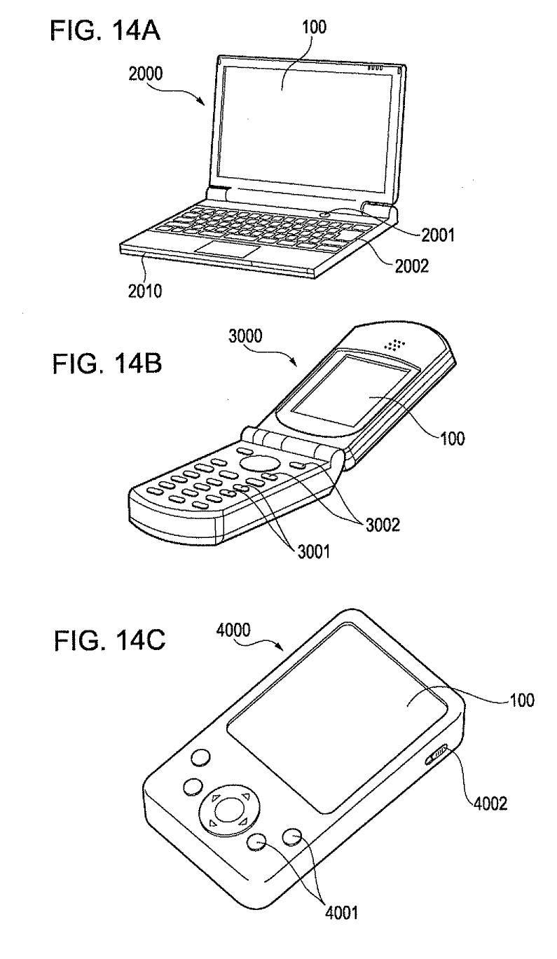

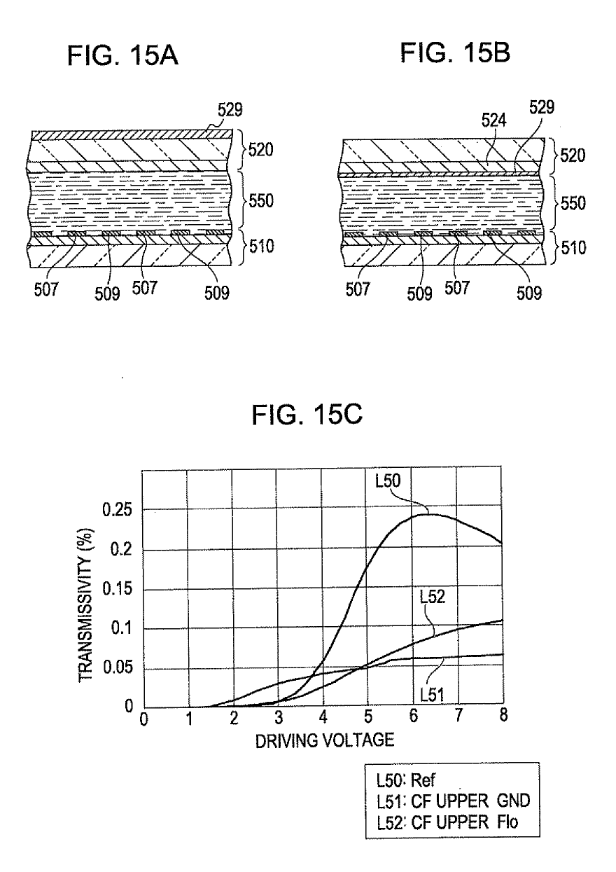

Next, an electronic apparatus equipped with the liquid crystal device 100 according to the above-described configurations will be described. FIG. 14A is a diagram illustrating the configuration of a portable personal computer equipped with the liquid crystal device 100. A personal computer 2000 includes the liquid crystal device 100 as a display unit and a main body 2010. The main body 2010 is provided with a power switch 2001 and a keyboard 2002. FIG. 14B is a diagram illustrating the configuration of a cellular phone equipped with the liquid crystal device 100. A cellular phone 3000 is provided with a plurality of operational buttons 3001, scroll buttons 3002, and the liquid crystal device 100 as a display unit. A screen displayed on the liquid crystal device 100 is scrolled by operation of the scroll buttons 3002. FIG. 14C is a diagram illustrating the configuration of a personal digital assistant (PDA) equipped with the liquid crystal device 100. A personal digital assistant 4000 is provided with a plurality of operational buttons 4001, a power switch 4002, and the liquid crystal device 100 as a display unit. Various kinds of information such as an address book or a schedule book are displayed on the liquid crystal device 100 by operation of the power switch 4002.

In addition to the electronic apparatus shown in FIGS. 14A, 14B, and 14C, examples of the electronic apparatus equipped with the liquid crystal device 100 include a digital still camera, a liquid crystal TV, a view finder type or monitor direct vision-type video tape recorder, a car navigation apparatus, a pager, an electronic pocket book, a calculator, a word processor, a work station, a television phone, a POS terminal, and an apparatus having a touch panel. The liquid crystal device 100 described above is applicable as a display unit of these electronic apparatuses.

The entire disclosure of Japanese Patent Application No. 2008-004015, filed Jan. 11, 2008 is expressly incorporated by reference herein.

What is claimed is:

1. A liquid crystal device comprising:
lower electrodes which are formed in an element substrate;
an insulating film which is stacked on the lower electrodes;
upper electrodes which are stacked on the insulating film and each provided with a slit for generating a fringe electric field;
a counter substrate which is formed opposite the element substrate;
liquid crystal which is interposed between the counter substrate and the element substrate;
a shield electrode which is formed in a potentially floating state on an inner surface of the counter substrate opposed to the element substrate; and
a resin layer which is formed on the inner surface of the counter substrate.

2. The liquid crystal device according to claim 1, wherein the shield electrode and the resin layer are formed in order from the counter substrate on the inner surface of the counter substrate.

3. The liquid crystal device according to claim 1, wherein the resin layer and the shield electrode are formed in order from the counter substrate on the inner surface of the counter substrate.

4. A liquid crystal device comprising:
lower electrodes which are formed in an element substrate;
an insulating film which is stacked on the lower electrodes;
upper electrodes which are stacked on the insulating film and each provided with a slit for generating a fringe electric field;
a counter substrate which is formed opposite the element substrate;
liquid crystal which is interposed between the counter substrate and the element substrate;
a shield electrode which is formed on an inner surface of the counter substrate opposed to the element substrate; and
a resin layer which is stacked next to the shield electrode from the counter substrate,
wherein a pixel electrode is formed of one of the lower electrode and the upper electrode and a common electrode is formed of the other thereof, and
wherein the shield electrode is opposed to the common electrode and a potential having an absolute value higher than that of a common potential applied to the common electrode and having the same polarity as that of the common voltage is applied to the shield electrode.

5. The liquid crystal device according to claim 4, wherein the shield electrode is electrically connected to a wire formed on the element substrate through an electric conductive member interposed between the element substrate and the counter substrate.

6. The liquid crystal device according to claim 4,
wherein the common electrode and the shield electrode extend in a strip shape along pixels arranged in a horizontal direction or a vertical direction and are divided in a direction intersecting the extension direction, and
wherein different common potentials are applied to adjacent common electrodes.

7. The liquid crystal device according to claim 2, wherein the resin layer has a thickness of 2 μm or more and permittivity of 6 or less.

8. The liquid crystal device according to claim 2, wherein the resin layer includes a color filter layer.

9. An electronic apparatus comprising the liquid crystal device according to claim 1.
